(19) United States
(12) Patent Application Publication
(10) Pub. No.: US 2009/0108667 A1
(43) Pub. Date: Apr. 30, 2009

(54) Molded Wheel with Integral Hub

(75) Inventors: Warren Clark, Evans, GA (US); Anthony J. Sanville, Evans, GA (US); Donald S. Hanson, Evans, GA (US); Richard Krall, Augusta, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/924,790

(22) Filed: Oct. 26, 2007

(51) Int. Cl. B60B 27/02

(52) U.S. Cl. 301/105.1

(57) ABSTRACT

A unitary wheel and hub assembly is provided. In accordance with various embodiments the wheel and hub assembly includes a molded wheel having a hub integrally molded therewith. The wheel and hub assembly additionally includes a hub sub-assembly integrally formed with the hub to form a unitary wheel and hub assembly that can be directly rotatably mounted on a wheel shaft of a vehicle.

### FIELD

The present teachings relate to a molded vehicle wheel having an integral hub and hub sub-assembly.

### BACKGROUND

The statements in this section merely provide background information related to the present disclosure and may not constitute prior art.

Most land vehicles include two or more wheels on which pneumatic tires are mounted to provide a rolling surface for movement of the vehicle. For example, many known light-weight utility vehicles, such as small cargo/maintenance vehicles, shuttle vehicles or golf cars, include three or more wheels, at least one of which is mounted on a wheel shaft of the vehicle suspension. Generally, such wheels have a two-part steel construction including an outer rim and an inner rim that are welded together to form the wheel on which the tire is mounted and inflated.

To mount the wheel and tire assembly on the wheel shaft of the vehicle, typically two conical bearings are mounted on the shaft and a hub assembly is mounted over the bearings. The hub assembly typically includes a wheel mounting plate welded to, or formed with, a cylindrical hub that is mounted over the bearings. Once the hub assembly is mounted over the bearings, the hub assembly is rotatably secured to the shaft. The wheel mounting plate typically includes a plurality of threaded studs that are spaced to match holes in the wheel. Therefore, the wheel, with the mounted tire, can be mounted on the hub assembly by inserting the threaded studs through the holes in the wheel. Wheel mounting nuts are then threaded onto the threaded studs to secure the wheel and tire to the hub, which is rotatably secured to the shaft.

Such known multi-part wheel and hub assemblies are costly and time consuming to assemble.

### SUMMARY

A unitary wheel and hub assembly is provided. In accordance with various embodiments, the wheel and hub assembly includes a molded wheel having a hub integrally molded therewith. The wheel and hub assembly additionally includes a hub sub-assembly integrally formed with the hub to form a unitary wheel and hub assembly that can be directly rotatably mounted on a wheel shaft of a vehicle.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a side view of a vehicle including a unitary wheel and hub assembly, in accordance with various embodiments of the present disclosure.

FIG. 2 is an isometric view illustrating the unitary wheel and hub assembly shown in FIG. 1 rotatably mountable on a wheel shaft of a vehicle suspension, in accordance with various embodiments of the present disclosure.

FIG. 3 is an isometric cross-sectional view of the unitary wheel and hub assembly shown in FIG. 1, in accordance with various embodiments of the present disclosure.

FIG. 4 is an exploded view of the unitary wheel and hub assembly shown in FIG. 3, in accordance with various embodiments of the present disclosure.

FIG. 5 is a cross-sectional view of a hub sub-assembly included in the wheel and hub assembly shown in FIGS. 3 and 4, in accordance with various embodiments of the present disclosure.

FIG. 6 is cross-sectional view of the unitary wheel and hub assembly shown in FIG. 1 illustrating centering indentions in an outer sleeve of the hub sub-assembly, in accordance with various embodiments of the present disclosure.

FIG. 7 is an isometric cross-sectional view of the unitary wheel and hub assembly shown in FIG. 1, in accordance with other various embodiments of the present disclosure.

FIG. 8 is an isometric cross-sectional view of the FIG. 7 is an isometric cross-sectional view of the unitary wheel and hub assembly shown in FIG. 1, in accordance with yet other various embodiments of the present disclosure.

### DETAILED DESCRIPTION

The following description is merely exemplary in nature and is in no way intended to limit the present teachings, application, or uses. Throughout this specification, like reference numerals will be used to refer to like elements.

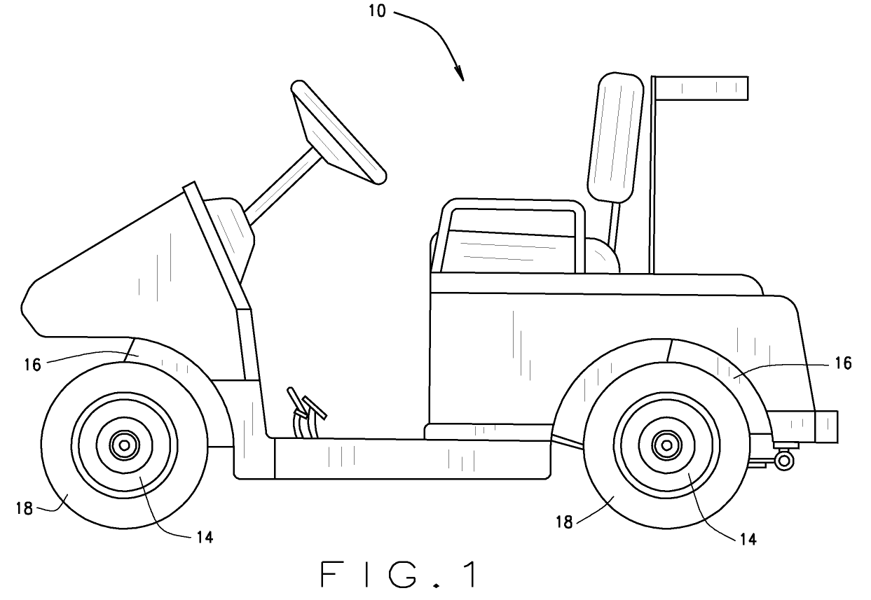

FIG. 1 illustrates a vehicle 10, such as a small cargo/maintenance vehicle, a shuttle vehicle or a golf car, that includes one or more unitary wheel and hub assemblies 14 rotatably mounted thereto. Particularly, the vehicle includes a suspension system 16 to which each wheel and hub assembly 14 is rotatably mounted, as described in detail below. Each wheel and hub assembly 14 is adapted to have a tire 18 mounted thereon to provide a rolling surface for movement of the vehicle 10. Although FIG. 1 illustrates the vehicle including wheel and hub assembly 14 employed as both a ‘front’ wheel and hub assembly 14 and a ‘rear’ wheel and hub assembly 14, it should be understood that the vehicle 10 can include one or more wheel and hub assemblies 14 and remain within the scope of the present disclosure. Thus, the vehicle 10 can include one or more ‘front’ wheel and hub assemblies 14 and/or one more ‘rear’ wheel and hub assemblies 14. However, although the vehicle 10 can include a plurality of wheel and hub assemblies 14, each wheel and hub assemblies 14 is substantially identical, thus, for clarity and simplicity, the description and figures herein will often simply reference a single wheel and hub assembly 14.

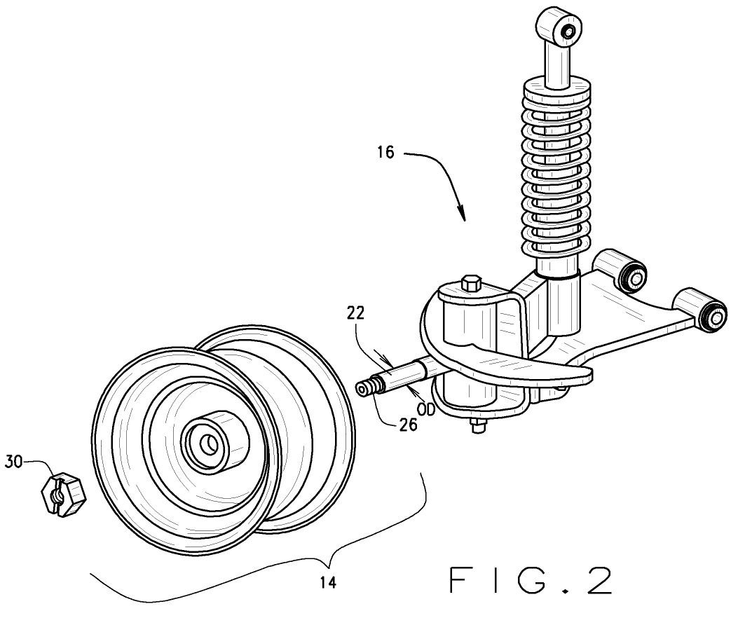

Referring now to FIG. 2, a portion of the vehicle suspension system 16 is illustrated including a wheel mounting shaft 22 onto which the wheel and hub assembly 14 is rotatably mounted. In various embodiments, wheel mounting shaft 22 includes a threaded end 26 adapted to threadably engage a castle nut 30. Accordingly, the wheel and hub assembly 14, as described in detail below, can be mounted onto the wheel shaft 22 and secured thereon by threading the castle nut 30 onto the threaded end 26 of the wheel mounting shaft 22.

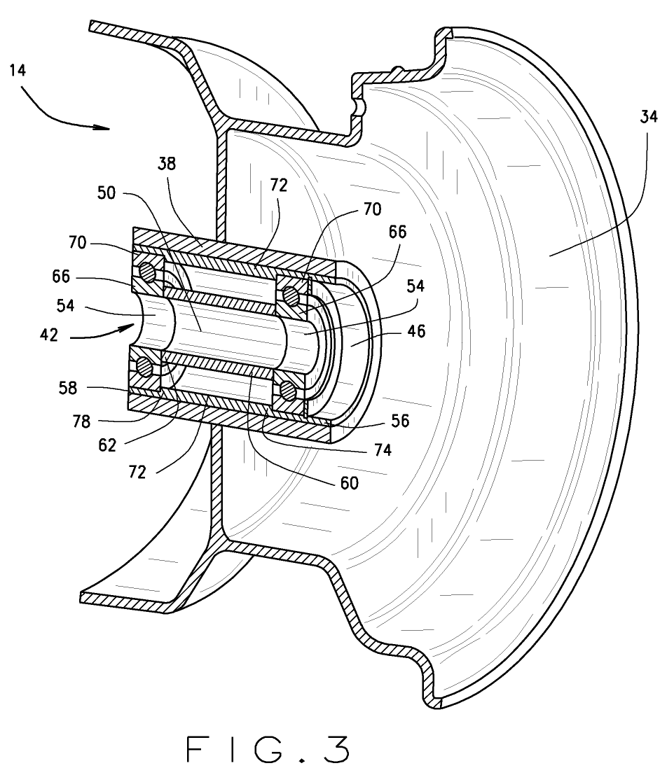

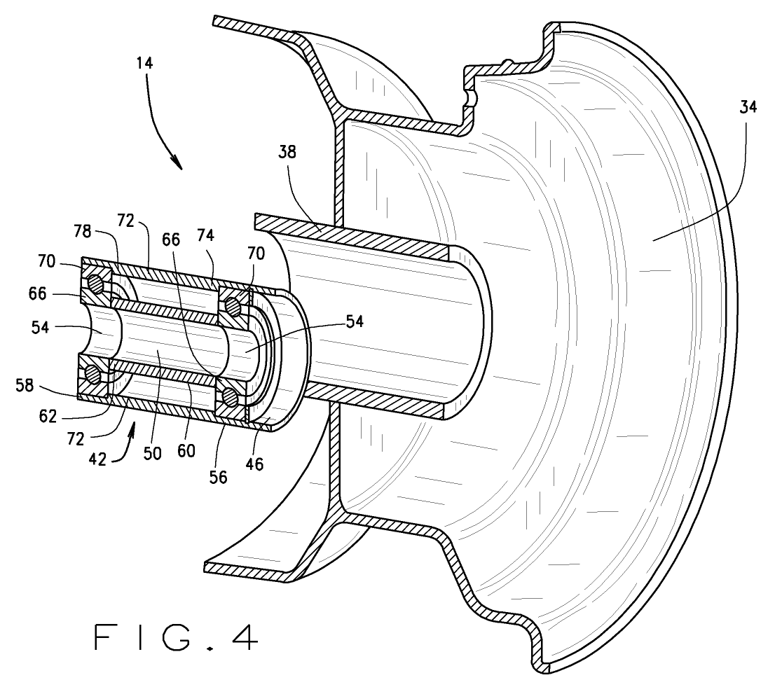

Referring now to FIGS. 3 and 4, the wheel and hub assembly 14 includes a molded wheel 34 having an integrally molded hub 38. The wheel 34 and integral hub 38 can be molded using any suitable molding process such as injection molding. The wheel 34 is molded to have a form that will accept a standard pneumatic tire. Additionally, the wheel 34 and integral hub 38 are molded using any material that will provide suitable strength, rigidity and flexibility. That is, the wheel 34 and integral hub 38 are molded using any material suitable for providing sufficient durability to withstand the stresses and strains that will be applied to the wheel 34 and integral hub 38 during operation of the vehicle 10. For example, in various embodiments, wheel 34 and integral hub 38 can be molded using various composite plastic materials such as a glass filled thermoplastic, e.g., polypropylene.

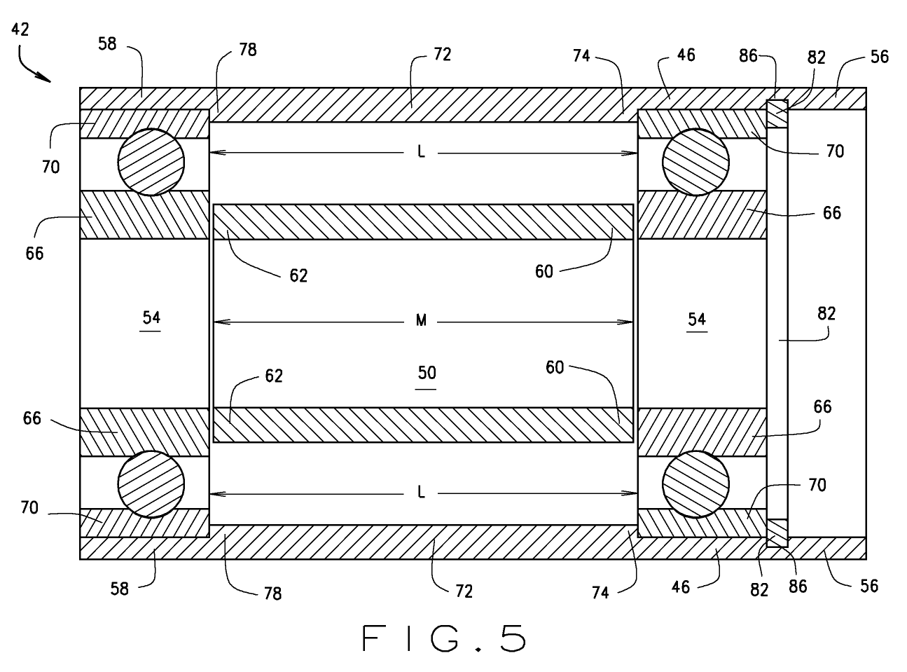

Referring additionally to FIG. 5, the wheel and hub assembly 14 additionally includes a hub sub-assembly 42 that is integrally formed with an interior portion of the hub 38. The hub sub-assembly 42 includes an outer sleeve 46, an inner bearing spacer sleeve 50 positioned within the outer sleeve 46, and a pair of bearings 54 that fit within opposing ends 56 and 58 of the outer sleeve 46.

The outer sleeve 46 is constructed to provide radial support to the hub 38 and stability to the wheel 34 and hub 38 during operation of the vehicle 10. More particularly, the outer sleeve 46 distributes radial and side loads across the hub 38 that are imparted on the hub 38 by the weight of the vehicle 10 and forces generated during operation of the vehicle 10. The outer sleeve 46 can be fabricated of any material having suitable strength and having any suitable dimensions to support and distribute the forces exerted on the hub 38.

For example, in various embodiments the outer sleeve 46 can be fabricated of steel or other suitable metal. In other various embodiments, the outer sleeve 46 can be fabricated of a suitable high strength plastic or composite having a wall thickness suitable for supporting and distributing such forces. The outer sleeve 46 is integrally formed, or joined, with the hub 38 such that the inner sleeve 46 can not be removed or separated from the hub 38 once the outer sleeve 46 is formed, or joined, with the hub 38. In various embodiments, the outer sleeve 46 can be press fit into the hub 38, while in other embodiments, the outer sleeve 46 can be molded into the hub 38.

In still other embodiments, the wheel 34 and hub 38 can be molded of high strength plastic or composite with the hub 38 having a wall thickness suitable for supporting and distributing such radial load and torque forces imparted on the hub 38 by the weight of the vehicle 10 and operation of the vehicle 10.

The inner sleeve 50 is constructed to bear the compression load between the bearings 54 when the wheel and hub assembly 14 is mounted and secured on the wheel shaft 22, as described below. The inner sleeve 50 can be fabricated of any material having suitable strength and dimensions to bear the compressive forces imparted on the inner sleeve when the nut 30 is tightened onto the shaft 22 to secure the wheel and hub assembly 14 on the shaft 22. For example, in various embodiments the inner sleeve 50 can be fabricated of steel or other suitable metal. In other various embodiments, the inner sleeve 50 can be fabricated of a suitable high strength plastic or composite having a wall thickness suitable for bearing such compression loads.

The bearings 54 can be any bearing suitable for use within a vehicle wheel hub, such as hub 38. For example, in various embodiments, the bearings 54 are sealed bearings having an inner race 66 and an outer race 70 that are pressed into the outer sleeve 46. In various implementations, the outer sleeve 46 includes a raised shoulder 72 integrally formed with, and extending radially inward from, an interior portion of the outer sleeve 46. The bearings 54 are pressed into the outer sleeve 46 until the bearings 54 are stopped by the raised shoulder 72. That is, when the bearings 54 are pressed into the outer sleeve 46, the outer races 70 will be stopped by and abut opposing ends 74 and 78 of the raised shoulder 72. The raised shoulder 72 has a predetermined longitudinal, or axial, length L, i.e., the longitudinal distance between the opposing ends 74 and 78, that spaces the bearing 54 apart at the specified length L. The shoulder 72 also positions the bearings 54 a predetermined distance from a center line of the wheel 34, thereby providing a proper balance of stresses imparted on the hub 38 and outer sleeve 46 during operation of the vehicle 10.

Additionally, the inner sleeve 50 has a predetermined longitudinal, or axial, length M, i.e., the longitudinal distance between the opposing ends 60 and 62. In accordance with various embodiments, the length M of the inner sleeve 50 is slightly shorter, e.g., 8/1000 of an inch to 12/1000 of an inch shorter, than the length L of the shoulder 72. When the unitary wheel and hub assembly 14 is mounted on the wheel shaft 22, threading and tightening the nut 30 onto the threaded shaft end 26 will retain the unitary wheel and hub assembly 14 on the shaft 22. More particularly, tightening the nut 30 onto the shaft 22 will force the inner races 66 of the bearings 54 axially inward, i.e., toward each other. Thus, tightening the nut 30 onto the shaft 22 with the wheel and hub assembly mounted on the shaft 22, will compress the inner races 66 axially inward and into abutment with the opposing ends 60 and 62 of the inner sleeve 50.

Therefore, since the length M of the inner sleeve 50 is slightly shorter than the length L of the outer sleeve shoulder 72, when the unitary wheel and hub assembly 14 is mounted and secured on the shaft 22, the inner races 66 will be aligned slightly axially inward from the outer races 70. This slight offset in alignment of the inner and outer races 66 and 70 preloads the bearings 54. Preloading the bearing 54 causes the bearings 54 and the hub 38 to operate as a single unit, thereby improving performance and reliability of the unitary wheel and hub assembly 14.

Referring now particularly to FIG. 5, in various embodiments, the hub sub-assembly 42 additionally includes a snap ring 82 mounted within a snap ring channel 86 formed within the interior portion of one end 56 of the outer sleeve 46. More particularly, the snap ring channel 86 is formed in the end 56 which is the distal end of the outer sleeve 46, i.e., the end of the outer sleeve 46 that will be adjacent the nut 30 when the wheel and hub assembly 14 is mounted on the shaft 22. The snap ring holds the respective bearing 54 from moving axially outward away from the respective shoulder end 74 prior to mounting the wheel and hub assembly 14.

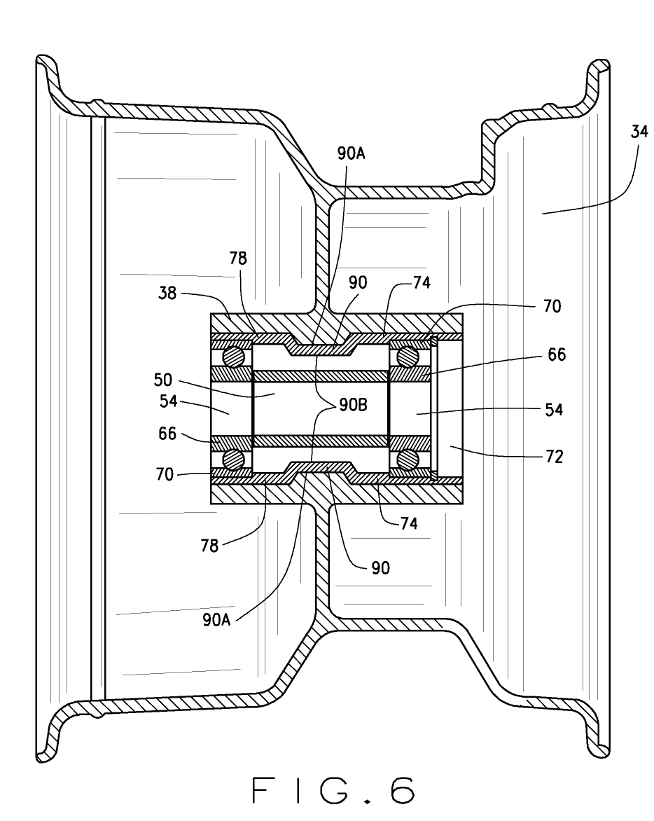

Referring now to FIG. 6, in various embodiments, the outer sleeve 46 additionally includes a plurality of centering indentions 90 that protrude radially inward. More particularly, the wall of the outer sleeve 46 includes the centering indentions 90 such that an outer surface of the outer sleeve 46 includes indentions 90A while the inner surface of the outer sleeve 46 includes protrusions 90B. The indentions 90A in the outer surface sleeve allow the hub 38 to extend into the indentions 90A if the outer sleeve is molded into the hub 38, thereby locking the outer sleeve 46 in place within the hub 38. The protrusions 90B generally keep the inner sleeve 50 axially centered within the outer sleeve 46 prior to mounting the wheel and hub assembly 14 onto the shaft 22.

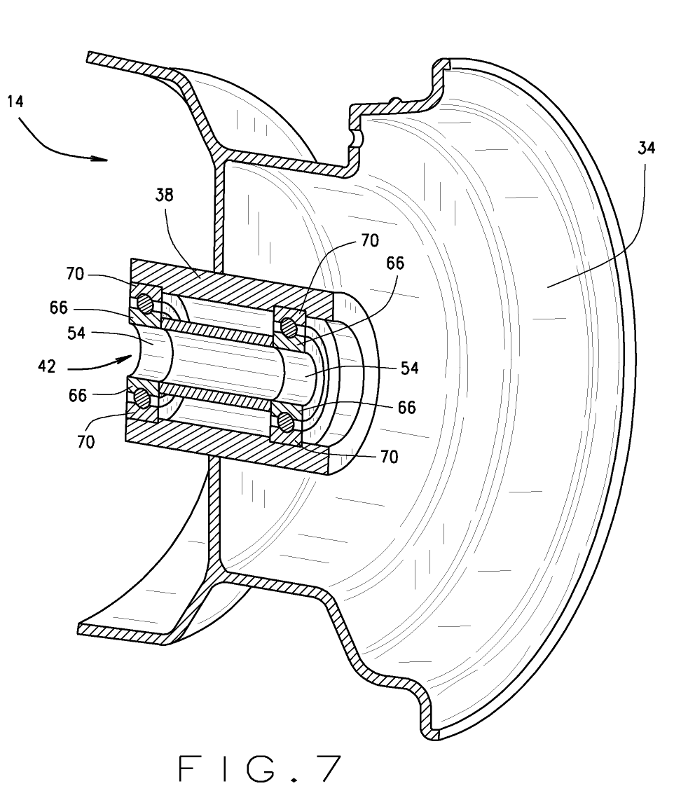

FIG. 7 illustrates an isometric cross-sectional view of the unitary wheel and hub assembly 14, in accordance with other various embodiments. In such embodiments, the hub sub-assembly 42 includes only the pair of opposing bearings 54. The hub sub-assembly 42 is integrally formed with the interior portion of the hub 38 by molding the bearings 54 into the hub 38 during the molding process of the wheel 34 and hub 38. Accordingly, the outer races 70 are embedded within the hub 38, thereby fixedly holding the bearings 54 in place within the hub 38 by being molded into the hub 38. The wheel and hub assembly 14 is mounted on the shaft 22 and the castle nut 30 is tighten to a desired torque, using a torque wrench, that will properly preload the bearings 54, as described above. In such embodiments, the unitary wheel and hub assembly 14 is relatively non-serviceable and disposable.

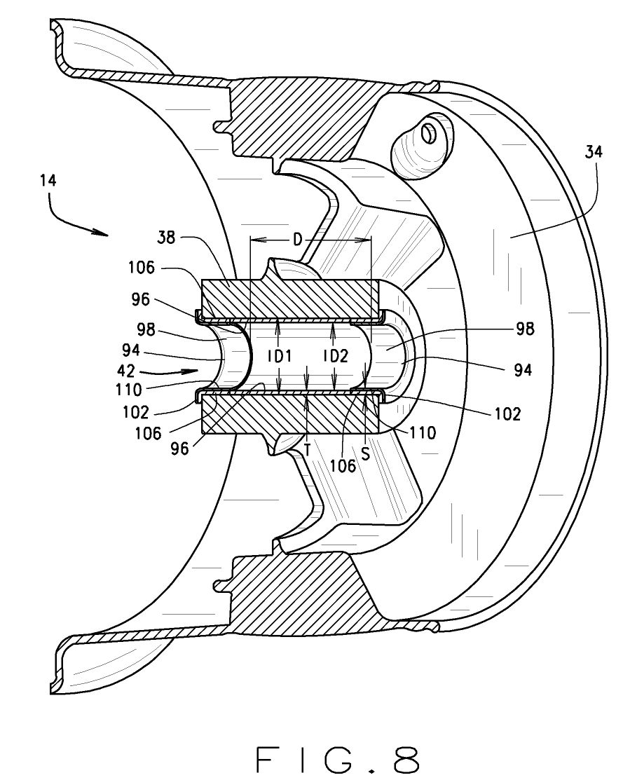

FIG. 8 illustrates an isometric cross-sectional view of the unitary wheel and hub assembly 14, in accordance with still other various embodiments. In such embodiments, the hub sub-assembly 42 includes a pair of opposing low-friction bushings 94 and an inner bushing spacer sleeve 96. More specifically, the wheel hub 38 is integrally formed with the wheel 34 such that an insider diameter ID1 of the wheel hub 38 is sized to frictionally receive the bushing spacer sleeve 96. In various embodiments, the bushing spacing sleeve 96 is fabricated from steel or other suitable metal and can be press fit, or molded, into the hub 38. Additionally, an inside diameter ID2 of the bushing spacer sleeve 96 is sized to be slightly larger than an outside diameter OD of the wheel shaft 22 (shown in FIG. 2).

Each of the low-friction bushings 94 includes an inner leg 98 and an outer leg 102. In various embodiments, the low-friction bushings 94 are pressed into opposing ends of the wheel hub 38 such that the inner legs 98 extend into an interior portion of the wheel hub 38 and the outer legs 102 abut outer end surfaces 104 of the wheel hub 38. In other embodiments, the low-friction bushing 94 can be molded into the ends of the wheel hub 38.

The bushing spacer sleeve 96 is similar in design and functions as the bearing spacer sleeve 50, described above. That is, the bushing spacer sleeve 96 has a predetermined longitudinal, or axial, length that is slightly shorter, e.g., 8/1000 of an inch to 12/1000 of an inch shorter, than a distance D between distal ends of the inner legs 98 of the opposing bushings 94. When the unitary wheel and hub assembly 14 is mounted on the wheel shaft 22, threading and tightening the nut 30 onto the threaded shaft end 26 will force the inner legs 98 of the bushings 94 axially inward, i.e., toward each other. Thus, tightening the nut 30 onto the shaft 22 with the wheel and hub assembly 14 mounted on the shaft 22, will compress the inner legs 98 axially inward and into abutment with the opposing ends of the bushing spacer sleeve 96. This preloads the bushing 94 much in the same way as the bearing 54 are preloaded, as described above, thereby causing the bushings 94 and the hub 38 to operate as a single unit and improving performance and reliability of the unitary wheel and hub assembly 14.

When the wheel and hub assembly 14 is mounted on the shaft 22, the bushing inner legs 98 lightly contact the outer surface of the shaft 22. However, the bushing spacer sleeve 96 has thickness T that is slightly less than a thickness S of the bushing inner legs 98. Thus, although the bushing inner legs lightly contact the outer surface of the shaft 22, a small space, or gap, will exist between the shaft 22 and the bushing spacer sleeve 96. For example, the space between the shaft 22 and the bushing spacer sleeve 96 can be 0.5 mm to 1.0 mm. In various embodiments, the low-friction bushings 94 include a metal core 106 plated, or coated, with a low-friction material 110 such that the wheel and hub assembly 14 will rotate on the shaft 22 in a substantially frictionless manner. For example, in an exemplary embodiment, the low-friction bushings 94 comprises a steel core 106 having a Teflon® coating 110.

The description herein is merely exemplary in nature and, thus, variations that do not depart from the gist of that which is described are intended to be within the scope of the teachings. Such variations are not to be regarded as a departure from the spirit and scope of the teachings.

1. A wheel and hub assembly comprising a molded wheel having a hub integrally formed therewith, and a hub sub-assembly integrally formed with the hub to form a unitary wheel and hub assembly.

2. The assembly of claim 1, wherein the hub sub-assembly comprises an outer radial load dispersion sleeve integrally formed with an interior portion of the hub.

3. The assembly of claim 2, wherein the outer sleeve is press fit within the hub.

4. The assembly of claim 2, wherein the outer sleeve is molded within the hub.

5. The assembly of claim 2, wherein the hub sub-assembly further comprises a snap ring mounted within a snap ring channel formed within an interior portion of the outer sleeve.

6. The assembly of claim 2, wherein the hub sub-assembly further comprises an inner bearing spacer sleeve positioned within the outer sleeve.

7. The assembly of claim 6, wherein the hub sub-assembly further comprises a pair of opposing bearings fitted within the outer sleeve at opposing ends of the inner spacer.

8. The assembly of claim 7, wherein each bearing includes an outer race that abuts a respective one of a pair of opposing ends of a bearing shoulder integrally formed in an interior portion of the outer sleeve when the bearings are fitted within the outer sleeve.

9. The assembly of claim 8, wherein each bearing further includes an inner race that abuts a respective one of the opposing ends of the inner spacer when the wheel and hub assembly is mounted on a wheel shaft of a vehicle.

10. The assembly of claim 9, wherein a longitudinal distance between the opposing ends of the inner spacer is slightly shorter than a longitudinal distance between the opposing ends of the bearing shoulder, thereby preloading the bearings when the wheel and hub assembly is mounted on a wheel shaft of a vehicle.

11. The assembly of claim 9, wherein the hub sub-assembly further includes a mounting nut adapted to retain the wheel and hub assembly on a wheel shaft of a vehicle and compress the bearing inner races against the opposing ends of the inner spacer.

12. The assembly of claim 1, wherein the hub sub-assembly includes a pair of bearings pressed into an interior portion of the wheel hub.

13. (canceled)

14. A vehicle wheel and hub assembly comprising:
a molded wheel having a hub integrally formed therewith: and
a hub sub-assembly integrally formed with an interior portion of the hub, the hub sub-assembly including a pair of force preloadable bearings, the wheel and hub assembly forming a unitary wheel and hub assembly that can be directly rotatably mounted on a wheel shaft of a vehicle.

15. The assembly of claim 14, wherein the hub sub-assembly further comprises an outer radial load support sleeve integrally formed with the interior portion of the hub.

16. The assembly of claim 15, wherein the outer sleeve is one of press fit within the interior portion of the hub and molded within the interior portion of the hub.

17. The assembly of claim 15, wherein the hub sub-assembly further comprises an inner bearing spacer sleeve positioned within the outer sleeve.

18. The assembly of claim 17, wherein the bearings are fitted within the outer sleeve at opposing ends of the inner spacer.

19. The assembly of claim 18, wherein each bearing includes an outer race that abuts a respective one of a pair of opposing ends of a bearing shoulder when the bearings are fitted within the outer sleeve, the bearing shoulder integrally formed with the outer sleeve and protruding radially inward from an interior portion of the outer sleeve.

20. The assembly of claim 19, wherein the hub sub-assembly further comprises a snap ring mounted within a snap ring channel formed within the interior portion of the outer sleeve to hold the bearing outer races in abutment with the opposing ends of the bearing shoulder.

21. The assembly of claim 19, wherein each bearing further includes an inner race that abuts a respective one of the opposing ends of the inner spacer when the wheel and hub assembly is mounted on a wheel shaft of a vehicle.

22. The assembly of claim 21, wherein the hub sub-assembly further includes a mounting nut adapted to retain the vehicle wheel and hub assembly on a wheel shaft of the vehicle and compress the bearing inner races against the opposing ends of the inner spacer.

23. The assembly of claim 21, wherein a longitudinal distance between the opposing ends of the inner spacer is slightly shorter than a longitudinal distance between the opposing ends of the bearing shoulder, thereby force preloading the bearings when the wheel and hub assembly is mounted on a wheel shaft of a vehicle.

24. The assembly of claim 14, wherein the hub sub-assembly includes a pair of bearings pressed into an interior portion of the wheel hub

25. The assembly of claim 14, wherein the hub sub-assembly includes a pair of bearings molded into an interior portion of the wheel hub.

26. A vehicle comprising:
at least one wheel shaft; and
a unitary wheel and hub assembly mounted on each wheel shaft, each wheel and hub assembly including:
a molded wheel having a hub integrally molded therewith: and
a hub sub-assembly integrally formed with an interior portion of the hub, the hub sub-assembly including:
an outer radial load dispersion and support sleeve integrally formed with the interior portion of the hub, the outer sleeve having a bearing shoulder integrally formed with and protruding radially inward from an interior portion of the outer sleeve;
an inner bearing spacer sleeve positioned within the outer sleeve and having a longitudinal length that is slightly shorter than a longitudinal length of the bearing shoulder; and
a pair of bearings fitted within the outer sleeve, the bearings each including an outer race that abuts a respective one of opposing ends of the bearing shoulder when the bearing are fitted with the outer sleeve, and inner race of each bearing abuts a respective one of opposing ends of the inner spacer when the wheel and hub assembly is mounted on a wheel shaft of a vehicle, such that the bearings are force preloaded when the wheel and hub assembly is mounted on the wheel shaft of a vehicle.

27. The vehicle of claim 26, wherein the outer sleeve is one of press fit within the interior portion of the hub and molded within the interior portion of the hub.

28. The vehicle of claim 26, wherein the hub sub-assembly further comprises a snap ring mounted within a snap ring channel formed within the interior portion of the outer sleeve to hold the bearing outer races in abutment with the opposing ends of the bearing shoulder.

29. The vehicle of claim 26, wherein the hub sub-assembly further includes a mounting nut adapted to retain the wheel and hub assembly on the wheel shaft and compress the bearing inner races against the opposing ends of the inner spacer.

30. (canceled)
